(19) United States
(12) Patent Application Publication
(10) Pub. No.: US 2007/0181320 A1
(43) Pub. Date: Aug. 9, 2007

(54) Fence Post Driver and Remover

(76) Inventor: Robert Mason, Hugoton, KS (US)

Correspondence Address: MARTIN S. HIGH, P.O. BOX 217, STILLWATER, OK, 74076, US

(21) Appl. No.: 11/671,433

(22) Filed: Feb. 5, 2007

Related U.S. Application Data
(60) Provisional application No. 60/765,576, filed on Feb. 6, 2006.

(51) Int. Cl. B25D 11/00

(52) U.S. Cl. 173/90

(57) ABSTRACT

The instant invention, the fence post driver and remover, is comprised of a sliding ram and a stationary ram. The stationary ram is a hollow cylinder. To begin operation of the instant invention the stationary ram is placed over the end of the fence post. That is, for operation of the instant invention the fence post slides into the hollow formed by the stationary ram so that the instant invention rests on top of the top end of the fence post. The instant invention may be used to both drive fence posts and remove fence posts. In addition, the instant invention may be used in conjunction with any elongated objects to be driven into or removed from the ground.

### CROSS-REFERENCES TO RELATED APPLICATIONS

This application claims the benefit of U.S. Provisional Application No. 60/765,576 filed on Feb. 6, 2006 titled “Fence post driver and remover.” The entire contents of provisional application 60/765,576 are incorporated herein by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

Not applicable.

### BACKGROUND OF THE INVENTION

It is a common chore for ranchers, farmers and homeowners to install fencing on their property. One of the most economical styles of fencing is the t-post. T-post fencing requires the installation of the t-posts along the fence line, and installation of these posts is the first and most time consuming of the steps to construct a fence. Driving a t-post requires some type of driving device. The simplest would be a hammering device such as a sledge hammer. However, one must hold the t-post initially to position the post as the first few hammer blows are administered. This makes using a sledge hammer sometimes dangerous to use. Next, the installer must administer a number of blows to further drive the post or stake into the ground. Driving the post may be very difficult due to the diameter of the post or stake or the hardness of the ground. Devices used heretofore typically are heavy, requiring considerable user effort, dangerous or both.

It is common for landowners to drive other objects into the ground including anchors, other fencing products, electrical ground stakes. In many cases, the use of a sledge hammer or other hammer-like devices is dangerous or impossible to use.

### FIELD OF THE INVENTION

The field of the instant invention involves devices that install and remove fence posts.

### DESCRIPTION OF THE RELATED ART INCLUDING INFORMATION DISCLOSED UNDER 37 CFR 1.97 AND 1.98

Other t-post drivers have been developed that make use of simple hollow cylinders that are placed over the top of the t-post and repeatedly used to hammer the post into the ground. These devices have several short comings. First, the driver is typically very heavy. Second, at the initial installation of a fence post, the driver must be held high over the fence post to gain proper leverage to drive the post. Third, the drivers are able to only install fence post, and are not capable of removing fence posts. The instant invention teaches a device that is lighter in weight, comfortable to use, and is capable of both installing and removing fence posts.

### BRIEF SUMMARY OF THE INVENTION

The instant invention, the fence post driver and remover, is comprised of a sliding ram and a stationary ram. The stationary ram is a hollow cylinder which can accept the fence or stake into the hollow of the cylinder. To begin operation of the instant invention the stationary ram is placed over the end of the fence post or any other shaft to be driven into the ground. That is, for operation of the instant invention the fence post or shaft slides into the hollow formed by the stationary ram so that the instant invention rests on top of the top end of the fence post or shaft.

The instant invention may be used in a fence driving best mode and in a fence removing best mode. In the best mode of operation of the instant invention for driving fence posts into the ground, the instant invention is placed over the fence post so that the fence post extends into the stationary ram. In driving fence posts, the t-handle may be left loose or may be tightened to secure the fence post. In most instances, the t-handle is not tightened. The user then grasps the handles and repeatedly raises and lowers the sliding ram forcing the sliding ram to hammer onto the bottom collar. The force of the sliding ram hammering on the bottom collar is transferred through the stationary ram to the reinforced plug which is in turn affixed to the underside or inside of the top cap. The force is in turn transferred from the top cap to the top of the fence post or shaft hereby driving the fence post into the ground.

In the best mode of operation of the instant invention for removing fence posts from the ground, the instant invention is placed over the fence post so that the fence post extends into the stationary ram. In removing fence posts, the t-handle must be tightened to secure the fence post. The user then grasps the handles and repeatedly raises and lowers the sliding ram forcing the sliding ram to hammer up into the reinforced top cap. The force of the sliding ram hammering up into the top cap is transferred through the stationary ram to bottom collar, through the threaded aperture, through the t-handle to the fence thereby pulling the fence post shaft or stake upward and out of the ground.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be used as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

FIG. 1 is a perspective view of the Fence post driver and remover.

FIG. 2 is a front view of the Fence post driver and remover.

FIG. 3 is a side view of the Fence post driver and remover.

FIG. 4 is a top view of the Fence post driver and remover.

FIG. 5 is a bottom view of the Fence post driver and remover.

FIG. 6 is an exploded view of the Fence post driver and remover.

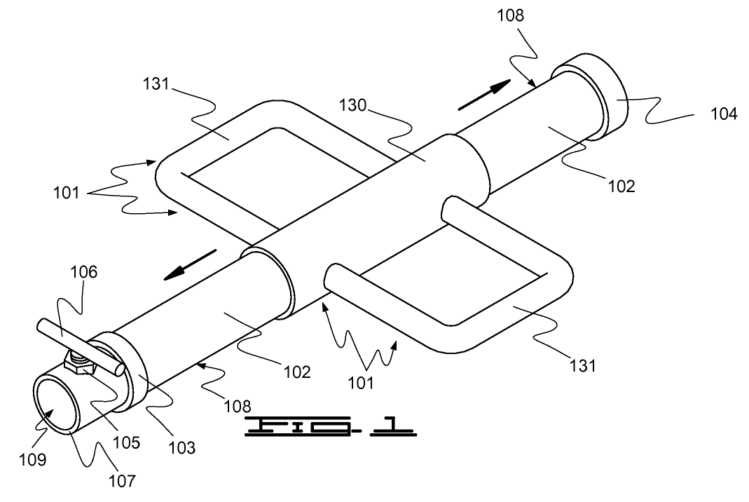

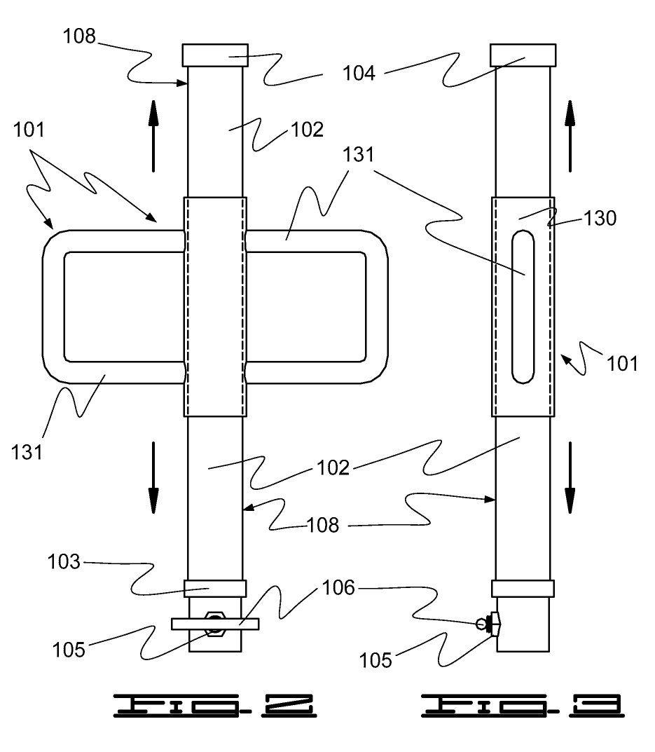

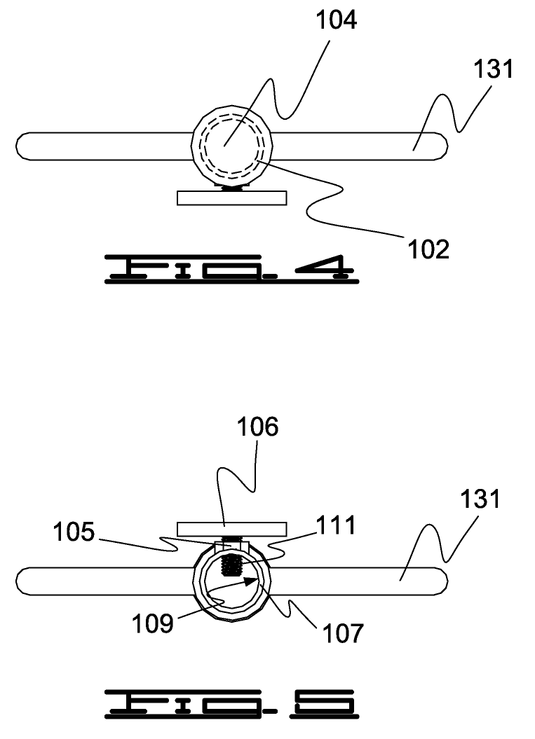

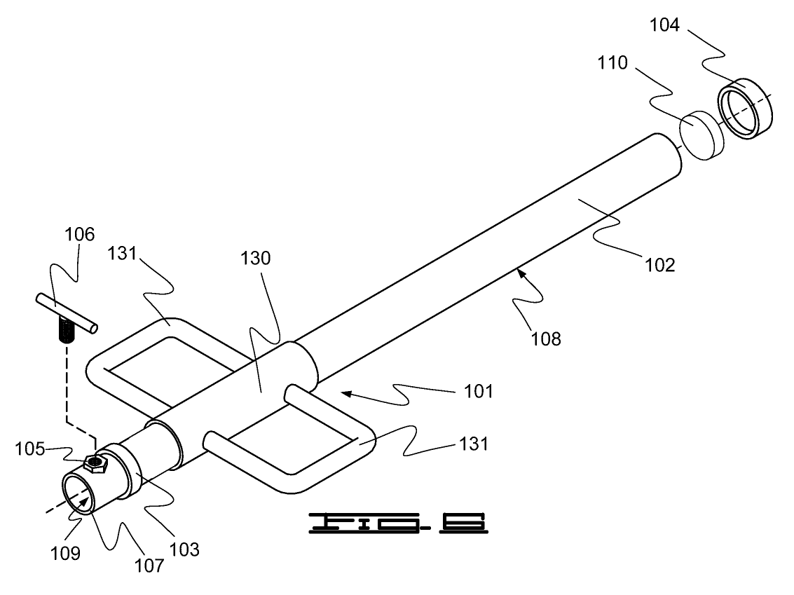

### DETAILED DESCRIPTION OF THE INVENTION

The instant invention, the fence post driver and remover, is comprised of a sliding ram 130 and a stationary ram 102. The instant invention is suitable to drive any elongated shaft into the ground, including, but not limited to, anchors, piping, grounding rods, round fencing, and t-post fencing. The stationary ram 102 is essentially a hollow cylinder. In addition, the instant invention can be resized to accommodate any sized elongated shaft, including, but not limited to, anchors, piping, grounding rods, round fencing, and t-post fencing, to be made more transportable for specialized use by adjusting the diameter of the hollow cylinder formed by the stationary ram 102.

To begin operation of the instant invention the stationary ram 102 is placed over the end of the fence post or any other shaft. That is, for operation of the instant invention the fence post slides into the hollow formed by the stationary ram 102 so that the instant invention rests on top of the top end of the fence post.

The stationary ram 102 is comprised of a bottom surface 107, a bottom collar 103, a top cap 104, a reinforcing plug 110, a threaded aperture 105, and a t-handle 106. The t-handle 106 is integrally manufactured with a threaded holding bolt 111 on the end opposite from the “T” portion of the t-handle. A bottom opening is formed by the bottom surface 107 of the stationary ram 102 and is the opening through which the fence post is inserted to begin operation of the instant invention. The bottom collar 103 is a ring welded onto the outside surface 108 of the stationary ram 102 near the bottom opening 107. The threaded aperture 105 is formed by outside surface 108 of the stationary ram 102 near the bottom opening 107.

The threaded aperture 105 is an opening that extends from the outside surface 108 to the inside surface 109 and allows for the threaded holding bolt 111 to be received into the threaded aperture 105. In one preferred embodiment of the instant invention, the threaded aperture 105 is a threaded nut welded onto the outside surface 108 of the stationary ram 102 thereby allowing a threaded end of the t-handle 106 to be inserted into the threaded aperture 105. The t-handle 106 can be tightened into the threaded aperture 105 so that the threaded end of the t-handle 111 makes contact with the fence post when inserted into the stationary ram 102.

The reinforcing plug 110 is welded into the top portion of the stationary ram 102, and the top cap 104 is welded on the top of the reinforcing plug 110 and the top of the stationary ram 102. The top cap 104 serves to close the top end of the stationary ram 102. When the instant invention is placed over the fence post, the top of the fence post rests on the bottom side of the reinforcing plug 110 which in turn rests on the bottom or inside of the top cap 104.

The sliding ram 101 is comprised of a sliding cylinder 130 and plurality of handles 131. The sliding cylinder 130 is essentially a hollow cylinder that slides upwards and downwards on the outside of the stationary ram 102. The reinforcing plug 110 is installed in the underside of the top cap 104 and held in place via a welded connection to top portion of the stationary ram 102. The sliding ram is installed onto the stationary ram before the bottom collar 103 or the top cap 104 is welded into place on the stationary ram 102. A plurality of handles 131 are permanently affixed to the sliding cylinder 130. In one preferred embodiment of the instant invention, the plurality of handles 131 is comprised of two handles. The plurality of handles 131 allows the user or users to grasp the sliding ram 101 and either push upward or downward depending on whether the user wishes to drive the fence post into the ground or remove the fence post from the ground.

All components of the instant invention are made from metal. In one preferred embodiment of the instant invention, all of the elements of the instant invention are made from either iron or steel. In another preferred embodiment of the instant invention, all of the elements of the instant invention are made from steel.

In the best mode of operation of the instant invention for driving fence posts into the ground, the instant invention is placed over the fence post so that the fence post extends into the stationary ram 102. In driving fence posts, the t-handle 106 with the holding bolt may be left loose or may be tightened to secure the fence post. In most instances, the t-handle 106 is not tightened. The user then grasps the handles 131 and repeatedly raises and lowers the sliding ram 101 forcing the sliding ram 101 to hammer onto the bottom collar 103. The force of the sliding ram 101 hammering on the bottom collar 103 is transferred through the stationary ram 102 to the top cap 104. The force is in turn transferred from the top cap 104 to the top of the fence post thereby driving the fence post into the ground.

In the best mode of operation of the instant invention for removing fence posts from the ground, the instant invention is placed over the fence post so that the fence post extends into the stationary ram 102. In removing fence posts, the t-handle 106 with the holding bolt must be tightened to secure the fence post. The user than grasps the handles 131 and repeatedly raises and lowers the sliding ram 101 forcing the sliding ram 101 to hammer up into the top cap 104. The force of the sliding ram 101 hammering up into the top cap 104 is transferred through the stationary ram 102 to bottom collar 103, through the threaded aperture 105, through the t-handle 106 to the fence thereby pulling the fence post upward and out of the ground.

What is claimed is:

1) A fence post driver and remover comprising
a stationary ram;
a sliding ram;
a bottom collar; and
a top cap.

2) A fence post driver and remover as described in claim 1 wherein the stationary ram is comprised of
a bottom surface,
a bottom collar,
a top cap,
a reinforcing plug,
a threaded aperture,
and a t-handle.

3) A fence post driver and remover as described in claim 2 wherein the sliding ram is comprised of a sliding cylinder and plurality of handles.

4) A fence post driver and remover as described in claim 3 wherein the t-handle is integrally manufactured with a threaded holding bolt and a “T” portion where the threaded holding bolt is on the end opposite from the “T” portion of the t-handle.

5) A fence post driver and remover as described in claim 3 comprising a bottom opening formed by the bottom surface of the stationary ram and is the opening through which the fence post is inserted to begin operation of the instant invention.

6) A fence post driver and remover as described in claim 5 wherein the bottom collar is a ring welded onto the outside surface of the stationary ram near the bottom opening.

7) A fence post driver and remover as described in claim 5 wherein the threaded aperture is formed by outside surface of the stationary ram near the bottom opening.

8) A fence post driver and remover as described in claim 7 wherein the threaded aperture is an opening that extends from the outside surface to the inside surface and allows for the threaded holding bolt to be received into the threaded aperture.

9) A fence post driver and remover as described in claim 8 wherein the threaded aperture is a threaded nut welded onto the outside surface of the stationary ram thereby allowing a threaded end of the t-handle to be inserted into the threaded aperture.

10) A fence post driver and remover as described in claim 3 wherein the reinforcing plug is welded into the top portion of the stationary ram and the top cap is welded on the top of the reinforcing plug and the top of the stationary ram.

11) A fence post driver and remover as described in claim 10 wherein all of the components are manufactured from iron or steel.
